(19) United States
(12) Patent Application Publication
(10) Pub. No.: US 2017/0041241 A1
(43) Pub. Date: Feb. 9, 2017

(54) MASKING TIMING INFORMATION

(71) Applicant: Nethanel Gelernter, Givat Shmuel (IL)

(72) Inventor: Nethanel Gelernter, Givat Shmuel (IL)

(21) Appl. No.: 14/817,276

(22) Filed: Aug. 4, 2015

(51) Int. Cl. H04L 12/841; G06F 11/07; G06N 7/00

(52) U.S. Cl. CPC H04L 47/28; G06N 7/005; G06F 11/0793; G06F 11/0709

(57) ABSTRACT

A method for masking timing information, the method comprises: receiving, by a masking unit, a request that is generated by a requesting entity and is aimed to a computerized system; receiving, from the computerized system, by receiver of the masking unit, a response to the request; calculating, by the masking unit, a duration of a delay period; wherein the calculating of the delay period may be responsive to at least one of the request and the response (or to none); and wherein when the response to the request is received before a target point in time then delaying, by the masking unit, a transmission of the response to the requesting entity, until the target point in time, thereby masking timing information about a response period of the computerized system; and wherein the target point in time exceeds a time of receiving the request by the delay period.

### BACKGROUND

Computerized systems such as servers (such as servers located in a cloud computing environment) are expected to respond to requests that are sent by user devices or other requesting entities.

When responding to a request, a computerized system may execute one or more operations. Typically, a complex operation will consume more time than a simple operation. For example, a multiplication operation may be more time consuming than a sum operation.

The response period of a computerized system may provide an indication about the one or more operations executed by the computerized system when responding to a request.

There is a growing need to mask timing information related to the response period of computerized systems.

### SUMMARY

There are provided systems, methods and non-transitory computer readable media, as illustrated in the claims.

According to an embodiment of the invention there may be provided a method for masking timing information, the method may include receiving, by a masking unit, a request that is generated by a requesting entity and is aimed to a computerized system; receiving, from the computerized system, by receiver of the masking unit, a response to the request; calculating, by the masking unit, a duration of a delay period; wherein the calculating of the delay period is responsive to at least one of the request and the response; and wherein when the response to the request is received before a target point in time then delaying, by the masking unit, a transmission of the response to the requesting entity, until the target point in time, thereby masking timing information about a response period of the computerized system; and wherein the target point in time exceeds a time of receiving the request by the delay period.

The calculating of the duration of the delay period follows the receiving of the response.

The calculating of the duration of the delay period precedes the receiving of the response and wherein the calculating of the delay period is responsive to the request and not to the response.

The calculating of the duration of the delay period precedes the receiving of the response and wherein the method further may include updating, after the receiving of the response, the delay period based on the response.

The calculating of the duration of the delay period may include applying a probability distribution function.

The method may include calculating or selecting the probability distribution function in response to the request.

The method may include receiving, by the masking unit, the probability distribution function.

The method may include calculating the probability distribution function in response to an expected success rate of the delaying; wherein a delaying failure occurs when the response to the request is not received before the target point in time.

The method may include monitoring an actual success rate of the delaying and changing the probability distribution function when the actual success rate deviates, by at least a deviation threshold, from the expected success rate.

The method may include detecting a delaying failure, wherein the delaying failure occurs when the response to the request is not received before the target point in time; and responding to the delaying failure.

The responding to the delaying failure may include sending a default response.

The responding to the delaying failure may include calculating a new target point in time.

The responding to the delaying failure may include transmitting the response to the requesting unit after the target point in time.

The method may include transmitting the response to the requesting unit upon a reception of the response by the masking unit.

The responding to the delaying failure may include calculating a new target point in time by applying the probability distribution function.

The method may include detecting a potential delaying failure and responding to the potential delaying failure; wherein the potential delaying failure occurs when the masking unit failed to receive the response until a predefined period before the target point in time.

The responding to the potential delaying failure may include transmitting to the requesting entity a default response.

The responding to the potential delaying failure may include calculating a new target point in time.

The responding to the potential delaying failure may include transmitting the response to the requesting unit after the target point in time.

The method may include transmitting the response to the requesting unit upon a reception of the response by the masking unit.

The method may include learning, by the masking unit, and during at least one learning period, distribution of response periods of the computerized unit.

The calculating of the duration of the delay period may include applying a probability distribution function; and wherein the method may include calculating the probability distribution function in response to the distribution of response periods of the computerized unit.

The method wherein during a given learning period of the at least one learning period no response is delayed.

The method wherein during a given learning period of the at least one learning period one or more responses are delayed.

The method may include searching, by the masking unit, for a type of requests that is associated with response periods that exceed a response period threshold.

The method may include delaying the transmission of the response only if the request belongs to first class of requests.

The method may include gathering, by the masking unit, delay period and response period statistics.

According to an embodiment of the invention there may be provided a non-transitory computer readable medium that stores instructions that once executed by a masking unit cause the masking unit to: receive a request that is generated by a requesting entity and is aimed to a computerized system; receive by receiver of the masking unit, a response to the request; calculate a duration of a delay period; wherein the calculating of the delay period is responsive to at least one of the request and the response; and wherein when the response to the request is received before a target point in time then delaying, by the masking unit, a transmission of the response to the requesting entity, until the target point in time, thereby masking timing information about a response period of the computerized system; and wherein the target point in time exceeds a time of receiving the request by the delay period.

According to an embodiment of the invention there may be provided a masking unit, may include a receiver, a transmitter, a processor and a memory unit; wherein the receiver is configured to receive a request that is generated by a requesting entity and is aimed to a computerized system and to receive from the computerized system, a response to the request; wherein the processor is configured to calculate a duration of a delay period; wherein the calculating of the delay period is responsive to at least one of the request and the response; and wherein when the response to the request is received before a target point in time then delaying, by the masking unit, a transmission of the response to the requesting entity, until the target point in time, thereby masking timing information about a response period of the computerized system; and wherein the target point in time exceeds a time of receiving the request by the delay period.

According to an embodiment of the invention there may be provided a method for masking timing information, the method may include receiving, by a masking unit, a request that is generated by a requesting entity and is aimed to a computerized system; receiving, from the computerized system, by receiver of the masking unit, a response to the request; calculating, by the masking unit, a duration of a delay period; wherein the calculating of the delay period is not responsive to the request and is not responsive to the response; and wherein when the response to the request is received before a target point in time then delaying, by the masking unit, a transmission of the response to the requesting entity, until the target point in time, thereby masking timing information about a response period of the computerized system; and wherein the target point in time exceeds a time of receiving the request by the delay period.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A illustrates a method according to an embodiment of the invention;

FIG. 1B illustrates a method according to an embodiment of the invention;

FIG. 1C illustrates a method according to an embodiment of the invention;

FIG. 1D illustrates a method according to an embodiment of the invention;

FIG. 1E illustrates a method according to an embodiment of the invention;

FIG. 2 illustrates a method according to an embodiment of the invention;

FIG. 3A illustrates a method according to an embodiment of the invention;

FIG. 3B illustrates a method according to an embodiment of the invention;

FIG. 4 illustrates a distribution of a response period according to an embodiment of the invention;

FIG. 5 illustrates distribution of a response period and of masked response periods according to an embodiment of the invention;

FIG. 6 illustrates a masking unit and its environment according to an embodiment of the invention;

FIG. 7 illustrates a masking unit and its environment according to an embodiment of the invention;

FIG. 8 illustrates a masking unit and its environment according to an embodiment of the invention;

FIG. 9 illustrates multiple time segments according to an embodiment of the invention; and

FIG. 10 is a transmission scheme according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

According to various embodiment of the invention there may be provided, systems, methods and conputer readable medium that store instructions that once executed by a computer cause the computer to prevent leakage of timing information through a channel.

According to an emnbodiment of the invention there is provided a method for masking timing information, a masking unit and a non-transitory computer readable medium that stores instructions for masking timing information. The timing information refers to a response period of a computerized system.

According to an embodiment of the invention the method, non-computer readable medium and masking unit may be implemented without changing the computerized system that is protected. Thus, the masking of timing information can be applied in a manner that is transparent to the computerized system that is protected.

In a nut shell, a masking unit may receive a request (from a requesting entity) aimed to a computerized system and may receive a response (of the computerized system) to the request. The masking unit may mask information of the timing of the response period by delaying the transmission of the response towards the requesting entity by a delay period.

The delay period may be determined after receiving the request but before receiving the response, after receiving the response and the request, may be determined based on the request, may be determined based on the response or may be determined based on the response and the request.

The delay period may be determined in response to the request and may be amended based on the response. The determining of the delay period may precede the receiving of the response and the updating may follow the receiving of the response. Yet according to an embodiment of the invention the delay period may be determined in advance—even before receiving the request.

In the following text the terms request and response may refer to any type of traffic sent to a computerized system and any type of traffic sent from the computerized system.

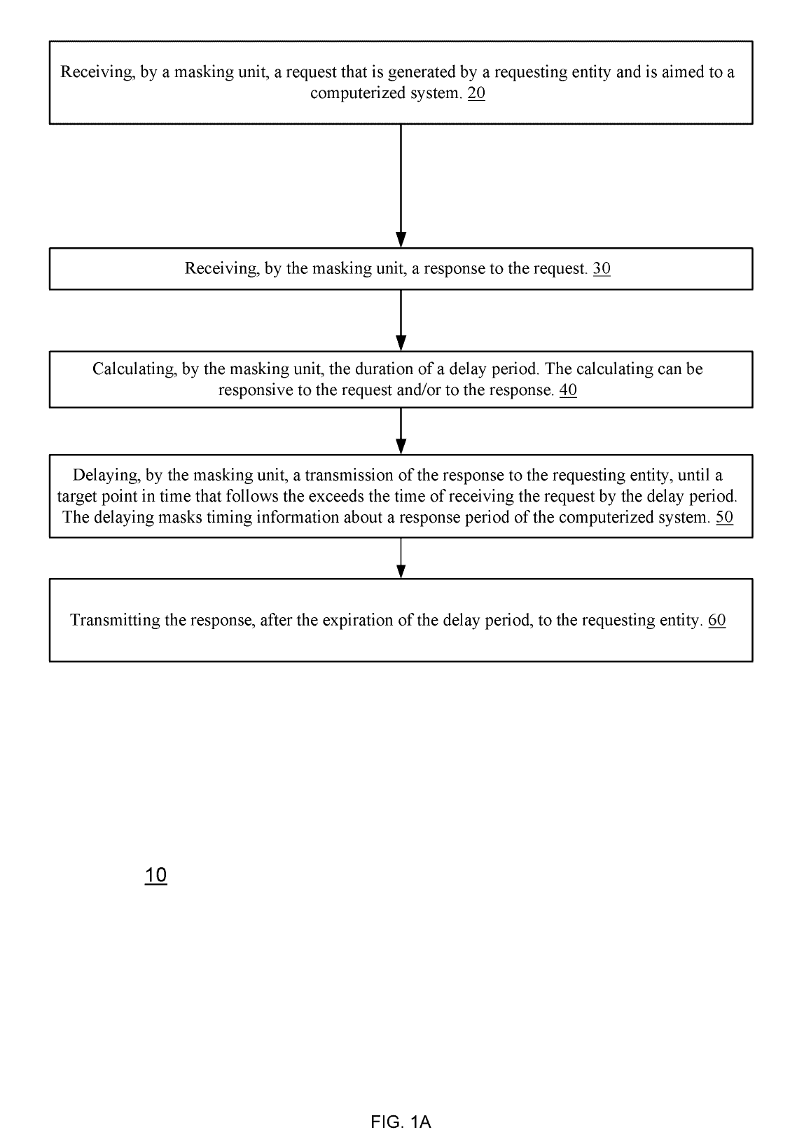

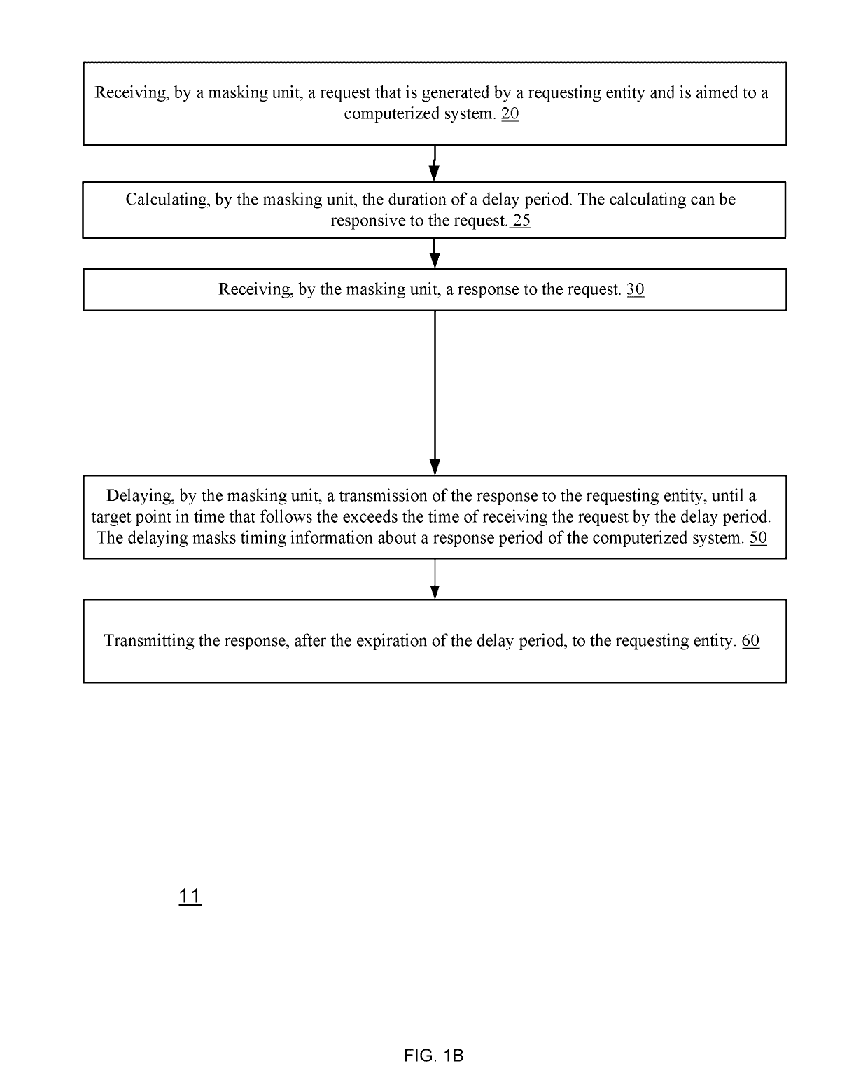

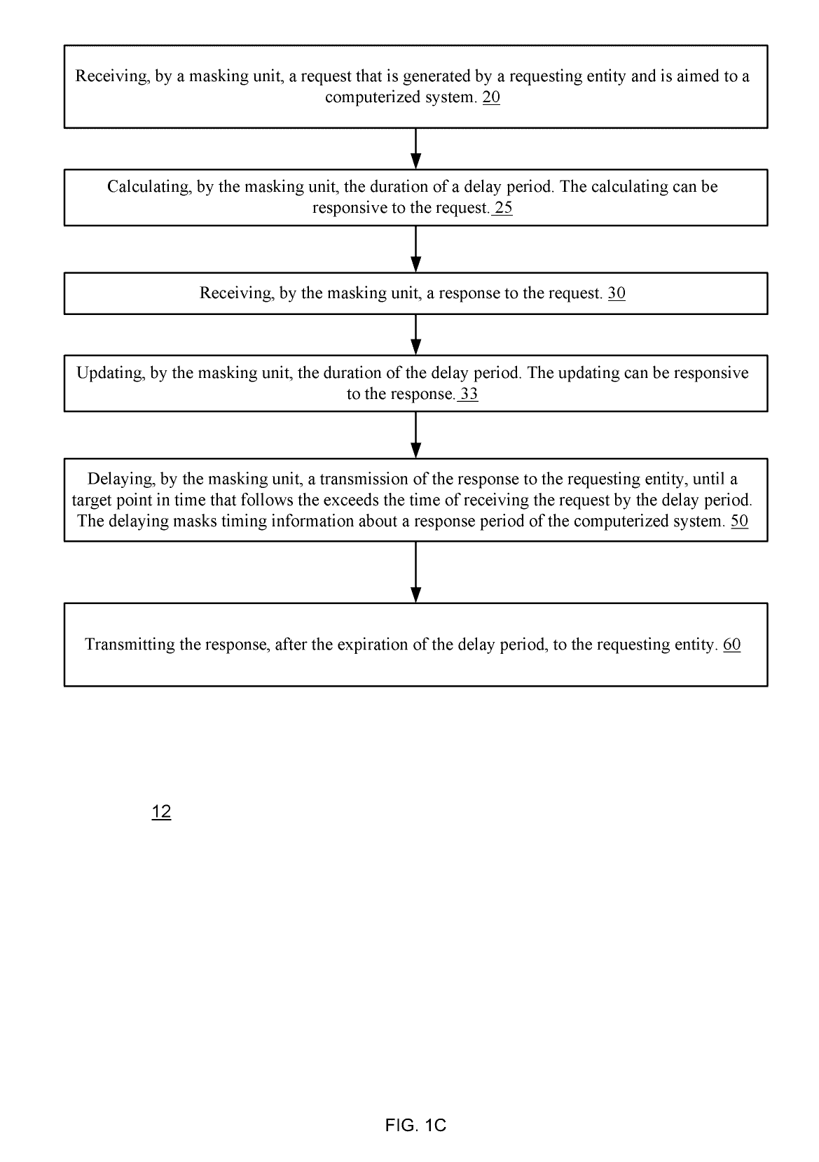

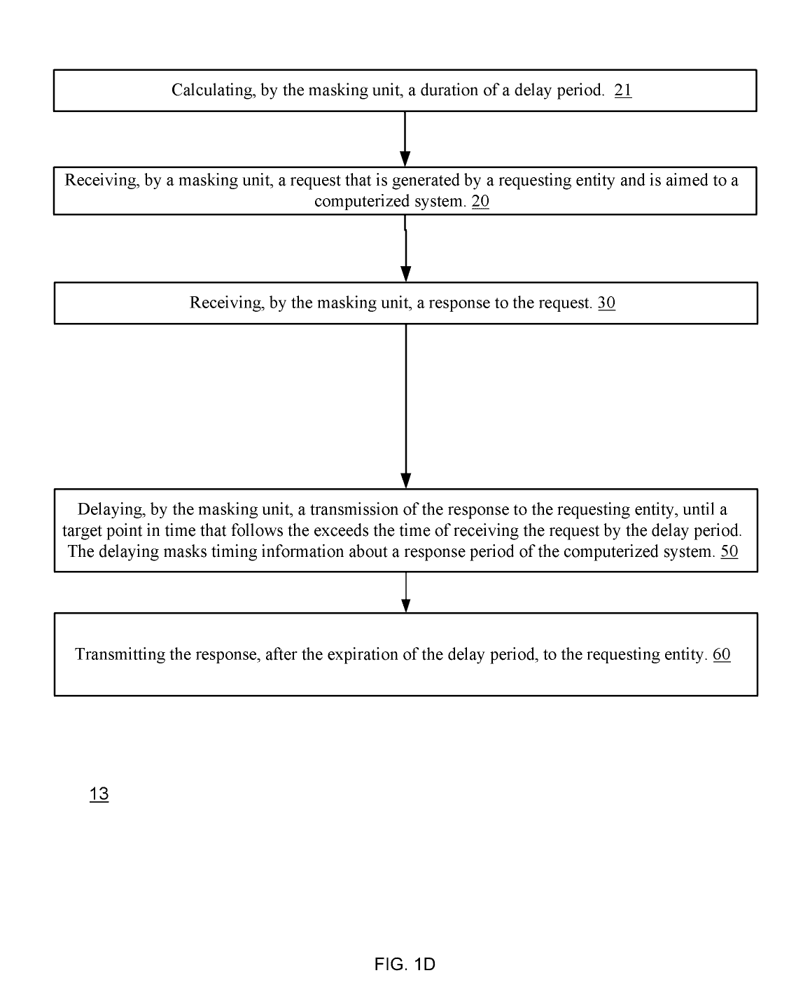

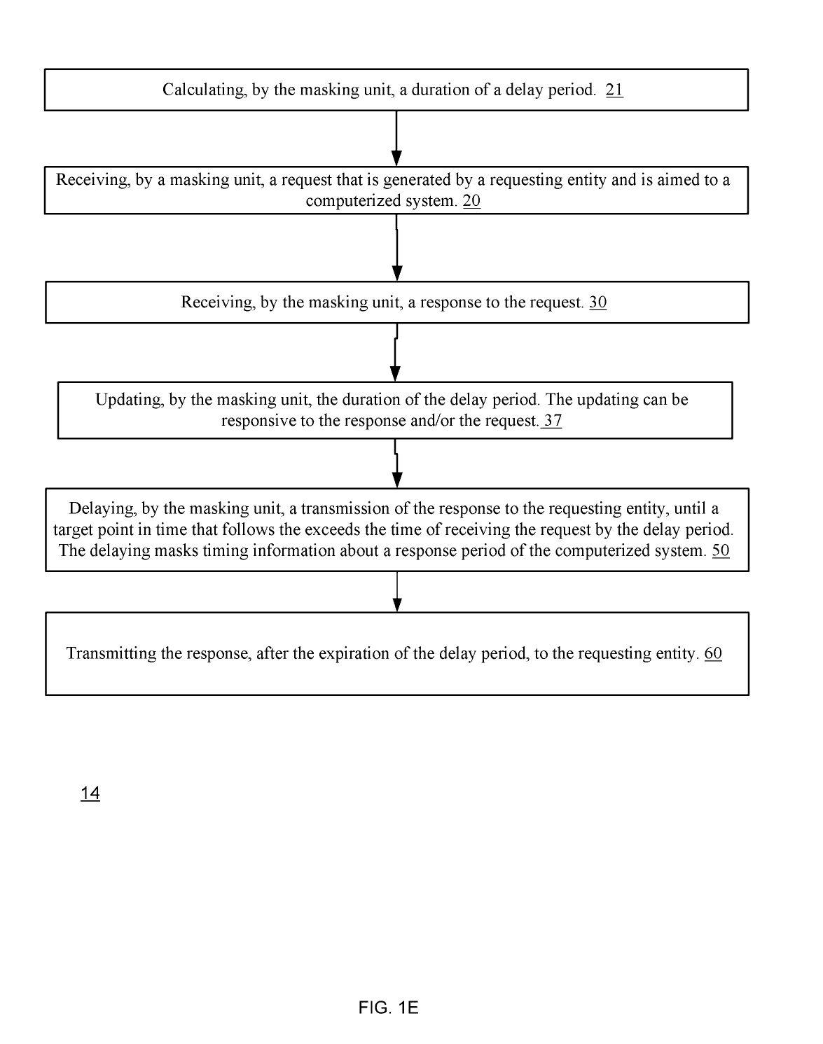

FIG. 1A illustrates method 10 according to an embodiment of the invention.

Method 10 may start by step 20 of receiving, by a masking unit, a request that is generated by a requesting entity and is aimed to a computerized system.

Step 20 may be followed by steps 30 and 40.

Step 30 may include receiving, by the masking unit, a response to the request.

Step 40 may include calculating, by the masking unit, the duration of a delay period. The calculating can be responsive to the request and/or to the response.

Step 40 may include applying a probability distribution function.

The probability distribution function may be calculated or selected in response to the request and/or the response. The probability distribution function can be defined by the type of the probability distribution function (for example a Gaussian probability distribution function, an exponential probability distribution function) and by its parameters such as average, standard deviation, exponent value and the like. Yet according to another embodiment the delay period may be determined regardless of the request or the response.

For example—one probability distribution function may be applied on requests that were rejected and one may be applied on requests that were accepted.

Yet for another example—one probability distribution function may be applied on requests generated during an authentication process and another probability distribution function may be applied on requests generated after a successful authentication process.

One or more parameters may change over time and/or from one first class of requests to another, and/or from one type of response to another.

Additionally or alternatively, the probability distribution function itself may change over time and/or from one first class of requests to another, and/or from one type of response to another.

Step 40 may be followed by step 50 of delaying, by the masking unit, a transmission of the response to the requesting entity, until a target point in time. The target point in time equals the time of the reception of the request plus the delay period. The delaying masks timing information about a response period of the computerized system. The response period of the computerized system includes the time that takes the computerized system to generate the response.

According to another embodiment of the invention the target point in time may be calculated in response to the time of reception of the response.

Step 50 may be followed by step 60 of transmitting the response to the requesting entity after the expiration of the delay period.

FIG. 1B illustrates method 11 according to an embodiment of the invention.

In method 11 the delay period is determined based on the request and not upon the response.

Method 11 includes the following sequence of steps 20, 25, 30, 50 and 60.

Step 20 may include receiving, by a masking unit, a request that is generated by a requesting entity and is aimed to a computerized system.

Step 25 may include calculating, by the masking unit, the duration of a delay period. The calculating can be responsive to the request.

Step 30 may include receiving, by the masking unit, a response to the request.

Step 50 may include delaying, by the masking unit, a transmission of the response to the requesting entity, until a target point in time. The target point in time equals the time of the reception of the request plus the delay period. The delaying masks timing information about a response period of the computerized system.

Step 60 may include transmitting the response to the requesting entity after the expiration of the delay period.

FIG. 1C illustrates method 12 according to an embodiment of the invention.

In method 12 the delay period is determined based on the request and may be updated after receiving the response.

Method 12 includes the following sequence of steps 20, 25, 30, 33, 50 and 60.

Step 20 may include receiving, by a masking unit, a request that is generated by a requesting entity and is aimed to a computerized system.

Step 25 may include calculating, by the masking unit, the duration of a delay period. The calculating can be responsive to the request.

Step 30 may include receiving, by the masking unit, a response to the request.

Step 33 may include updating the delay period. The updating may be responsive to the response. For example a response that rejects the request may be delayed by a different period than a response that accepts the request.

Step 50 may include delaying, by the masking unit, a transmission of the response to the requesting entity, until a target point in time. The target point in time equals the time of the reception of the request plus the delay period. The delaying masks timing information about a response period of the computerized system.

Step 60 may include transmitting the response to the requesting entity after the expiration of the delay period.

Yet according to another embodiment the delay period may be determined regardless of the request or the response. This is illustrated in FIG. 1D. Method 13 of FIG. 1D includes determining the delay period (step 21) before receiving the request or the response. It is noted that the delay period may be determined even after receiving the request and/or the response but the delay period may be calculated regardless of the request and regardless of the response.

Yet according to another embodiment the delay period may be determined regardless of the request or the response and then updated (see step 37 of FIG. 1E) in response to the request and/or the response.

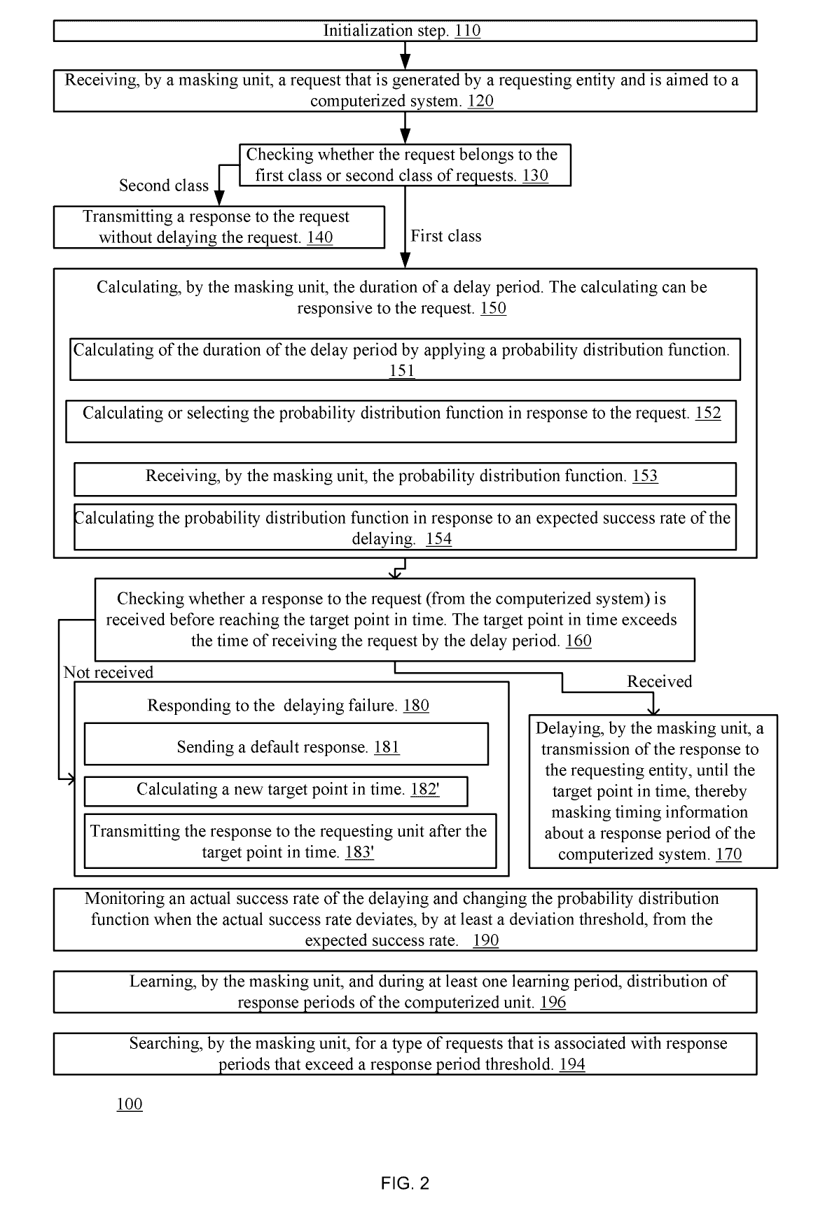

FIG. 2 illustrates method 100 according to an embodiment of the invention.

Method 100 may start by initialization step 110.

During initialization step 110 the masking unit can receive information about a first class of requests that should not be delayed by method 100 and about a second class of requests that should not be delayed by method 100.

It is noted that there may be multiple first classes and each first class may be associated with different masking parameters and/or different probability distribution functions.

The second class of requests may be transmitted to the requesting entity without delay.

The classification of the requests may be determined based upon an identity of the computerized system, an identity of the requesting entity, a service provided by the computerized system, a type of the request, a content of the request, and the like.

Step 110 may be followed by step 120 of receiving, by a masking unit, a request that is generated by a requesting entity and is aimed to a computerized system.

Step 120 may be followed by step 130 of checking whether the request belongs to the first class or second class of requests. The checking is compliant with the classification of requests of step 110.

If the request belongs to the second class then step 130 is followed by step 140 of transmitting a response to the request (once the response is received by the masking unit) without delaying the request.

If the request belongs to the first class then step 130 is followed by step 150 of calculating, by the masking unit, the duration of a delay period. The calculating can be responsive to the request.

Step 150 may include step 151 of calculating of the duration of the delay period by applying a probability distribution function.

The probability distribution function may determine a variable delay. A fixed offset may be added to the variable delay.

The probability distribution function may be calculated based upon the request.

For example—a response to a first request may be delayed by a delay period that is calculated by applying a first probability distribution function. A response to a second request may be delayed by a delay period that is calculated by applying a second probability distribution function. The second probability distribution function may differ from the second probability distribution function by average, standard deviation or by any other parameter.

Step 150 may include step 152 of calculating or selecting the probability distribution function based on the request.

The selection may responsive to a desired success rate.

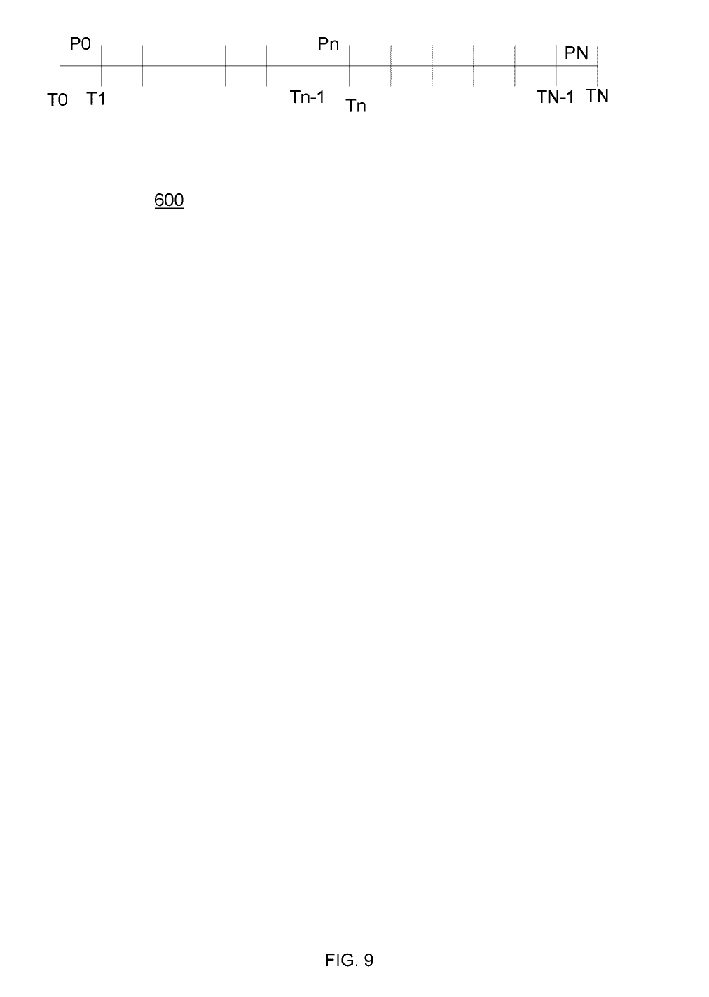

Assuming that the distribution of response period is known and can be calculated using a so-called actual probability distribution function. Step 152 may include:
a. Repeating, for various sets of parameters of the probability distribution function (associated with the delay period):
   i. Segmenting the time domain can be segmented to segments (see FIG. 9, timing diagram 600 illustrates N time periods P0-PN that are defined between points of time T0-TN. For each period (for example Pn, n ranged between 1 and N), calculates, for each Pn the probability that the actual time gap falls within Pn,
   ii. Calculating the probability that the delay period exceeds Pn using a certain set of parameters (such as fixed delay and exponent value).
   iii. Adding the products of these probabilities for each time segment.
b. Selecting the set of parameters that periods at least the predefined success rate and may have the smallest fixed delay or that fulfills any other optimization criterion.

Step 150 may include step 153 of receiving, by the masking unit, the probability distribution function. The probability distribution function can be provided to the masking unit by a system administrator, over a network, from the computerized system, and the like.

Step 150 may include step 154 of calculating the probability distribution function in response to an expected success rate of the delaying. Higher success rates may require longer delay periods.

A success rate of any probability distribution function can be calculated in various manners.

Step 150 may be followed by step 160 of checking whether a response to the request (from the computerized system) is received before reaching a target point in time. The target point in time exceeds the time of receiving the request by the delay period.

If the response to the request is received before the target point in time then step 160 is followed by step 170 of delaying, by the masking unit, a transmission of the response to the requesting entity, until the target point in time, thereby masking timing information about a response period of the computerized system.

If the response to the request is not received before the target point in time then a delaying failure occurred and step 160 is followed by step 180 of responding to the delaying failure.

Step 180 may include, for example, step 181 of sending a default response, step 182 of calculating a new target point in time and jumping to step 160, or step 183 of transmitting the response to the requesting unit after the target point in time.

Step 183 may include transmitting the response upon a reception of the response by the masking unit.

Step 182 may include calculating the new target point of time by applying the probability distribution function.

Method 100 may include step 190 of monitoring an actual success rate of the delaying and changing the probability distribution function when the actual success rate deviates, by at least a deviation threshold, from the expected success rate. Step 190 may be executed in parallel to other steps of method 100.

Step 190 may include calculating various parameters such as an average response period, a number of requests that were assigned with a delay period without a delaying failure, the number of delaying failures, and the like.

Method 100 may include step 194 of searching, by the masking unit, for a type of a request that is associated with a response period that exceed a response period threshold. For example—requests that will result with very long (for example several minutes) response periods may be used by a hacker during a denial of service attack. The masking unit may search for such requests and send an alert to a system administrator, generate the alert, store the alert, and the like.

Method 100 may include step 196 of learning, by the masking unit, and during at least one learning period, the distribution of response periods of the computerized unit. One distribution can be learnt per one type of request and/or for a combination of a request and a response to the request.

According to an embodiment of the invention the learning period the may precede the delaying of responses. For example—a given learning period may be performed before steps 150 and 170 occur. Thus, method 100 may include a given learning period during which the method is dedicated to learn the distribution of response periods of the computerized unit. Such a learning may be included, for example, in initialization step 110.

For example a credit card company may monitor responses to credit related requests for a predefined period and only then may decide (according to the distribution of the response of the credit system) whether to apply a masking scheme and if so—how to define the delay periods.

Step 196 may be executed during any step of method 100, before the execution of any step of method 100 or after the execution of any step of method 100.

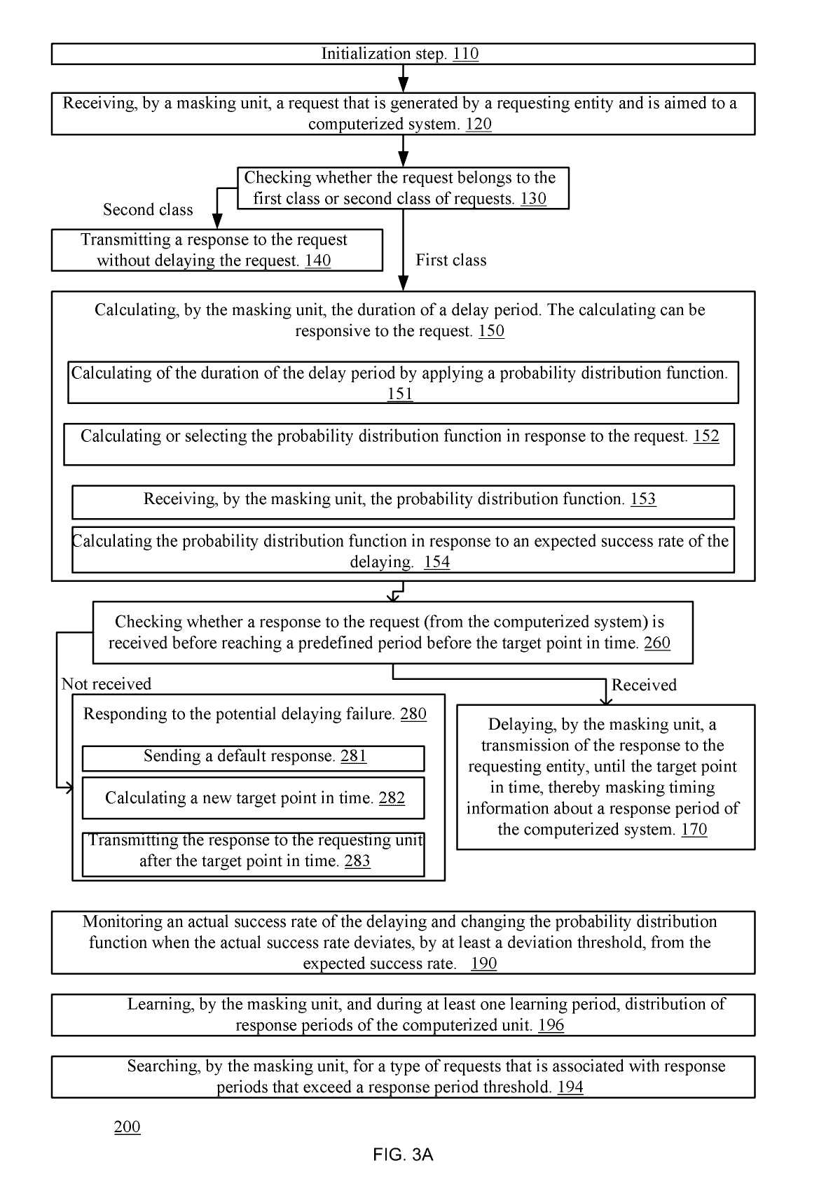

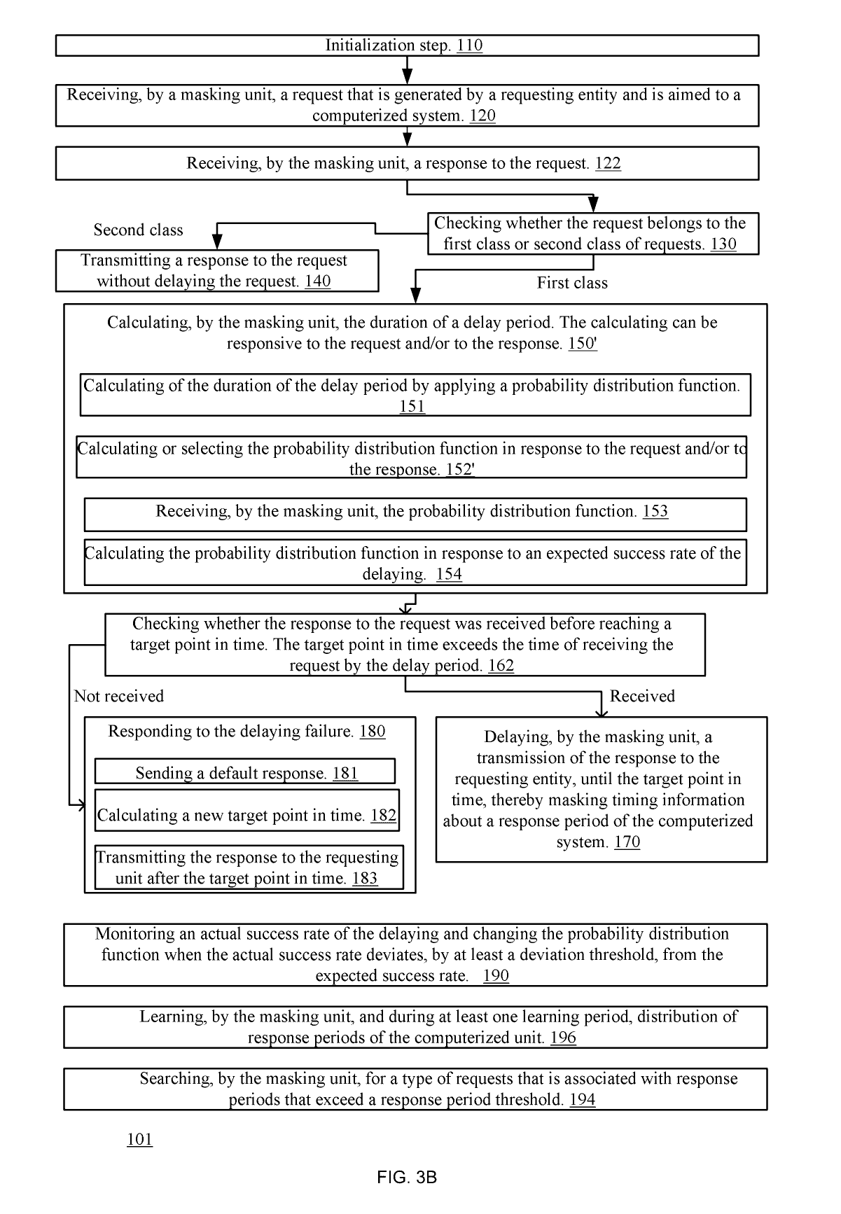

According to an embodiment of the invention any method mentioned above may evaluate (for example during a learning period such as in step 196 of FIG. 3B) that the computerized system is vulnerable—that the distribution of response periods clearly differentiates between different types of responses (for example there are distinguishes extremum points in the distribution).

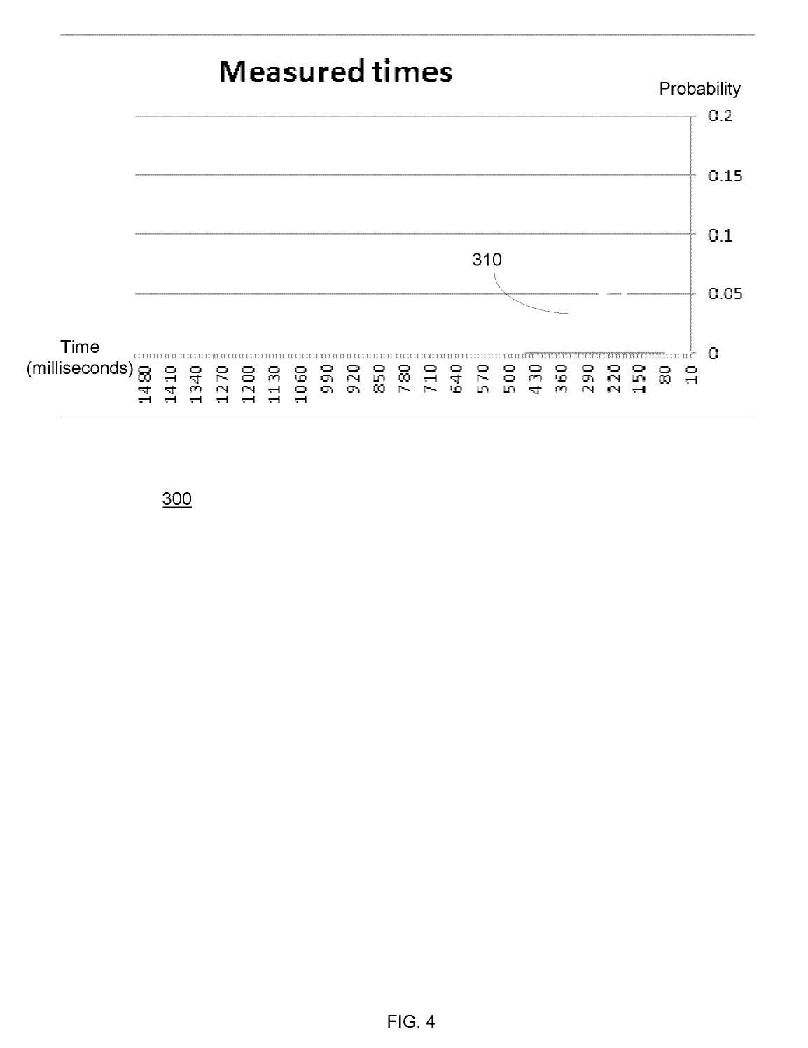

FIG. 4 includes graph 300 that includes a curve 310 that represents the distribution of the response periods. The x-axis represents the duration (in milliseconds) of the response period while the y-axis represents a probability.

Referring back to FIG. 3A—once step 196 is executed then the calculation (step 152) of the probability distribution function may be responsive to the distribution of response periods of the computerized unit.

For example—the probability distribution function once applied should result in delay periods that will mask the distribution of response periods.

For example—the probability distribution function should guarantee (with at least a predefined success rate) that the delay periods calculated by applying the probability distribution function are long enough in relation to the response periods.

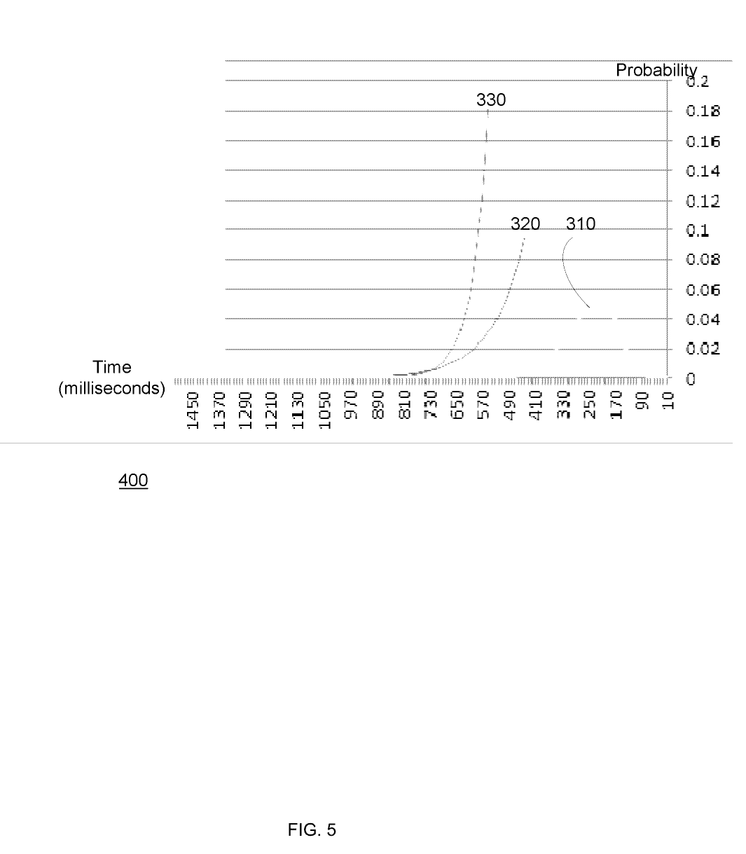

FIG. 5 includes graph 400 that includes curve 310 that represents the distribution of the response periods, curve 320 that represents an outcome of delaying the response by applying a first probability distribution function and curve 330 that represents an outcome of delaying the response by applying a second probability distribution function.

The first probability distribution function is an exponential distribution with lambda of 0.01. The first probability distribution function also adds a fixed delay of 440 milliseconds. The first probability distribution function has a security level of 0.3 percent (success rate of 99.7 percent).

The second probability distribution function is an exponential distribution with lambda of 0.02. The second probability distribution function also adds a fixed delay of 550 milliseconds. The second probability distribution function has a security level of 0.01 percent.

FIG. 3A illustrates method 200 according to an embodiment of the invention.

Method 200 differs from method 100 by detecting a potential delaying failure and not waiting till the target point of time is reached without receiving the response.

Instead of steps 160 and 180, method 200 includes steps 260 and 280.

Step 260 may be followed by step 170 or step 280.

Step 260 includes checking whether a response to the request (from the computerized system) is received before reaching predefined period before the target point in time. The predefined period may be of a predetermined length, may be a fixed fraction of the delay period or may be determined in any other manner.

If the response to the request is received before the predefined period before the target point in time then step 260 is followed by step 170 of delaying, by the masking unit, a transmission of the response to the requesting entity, until the target point in time, thereby masking timing information about a response period of the computerized system.

If the response to the request is not received before the predefined period before the target point in time then a potential delaying failure occurred and step 260 is followed by step 280 of responding to the potential delaying failure.

Step 280 may include step 281 of transmitting to the requesting entity a default response.

Step 280 may include step 282 of calculating a new target point in time and jumping to step 260.

Step 280 may include step 283 of transmitting the response to the requesting unit after the target point in time. Step 283 may include transmitting the response to the requesting unit upon a reception of the response by the masking unit.

FIG. 3B illustrates method 101 according to an embodiment of the invention.

Method 101 may start by initializing step 110.

Step 110 may be followed by step 120 of receiving, by a masking unit, a request that is generated by a requesting entity and is aimed to a computerized system.

Step 120 may be followed by step 122 of receiving, by the masking unit, a response to the request.

Step 122 may be followed by step 130 of checking whether the request belongs to the first class or second class of requests. The checking is compliant with the classification of requests of step 110.

If the request belongs to the second class then step 130 is followed by step 140 of transmitting a response to the request without delaying the request.

If the request belongs to the second class then step 130 is followed by step 150′ of calculating, by the masking unit, the duration of a delay period. The calculating can be responsive to the request and/or to the response.

Step 150′ may include step 151 of calculating of the duration of the delay period by applying a probability distribution function.

Step 150 may include step 152′ of calculating or selecting the probability distribution function in response to the request and/or to the response.

Step 150′ may include step 153 of receiving, by the masking unit, the probability distribution function.

Step 150′ may include step 154 of calculating the probability distribution function in response to an expected success rate of the delaying. Higher success rates may require longer delay periods.

Step 150 may be followed by step 162 of checking whether the response to the request was received before reaching a target point in time. The target point in time exceeds the time of receiving the request by the delay period.

If the response to the request was received before the target point in time then step 162 is followed by step 170 of delaying, by the masking unit, a transmission of the response to the requesting entity, until the target point in time, thereby masking timing information about a response period of the computerized system.

If the response to the request was not received before the target point in time then a delaying failure occurred and step 162 is followed by step 180 of responding to the delaying failure.

Step 180 may include, for example, step 181 of sending a default response, step 182 of calculating a new target point in time and jumping to step 160, or step 183 of transmitting the response to the requesting unit after the target point in time.

Method 101 may include step 190 of monitoring an actual success rate of the delaying and changing the probability distribution function when the actual success rate deviates, by at least a deviation threshold, from the expected success rate. Step 190 may be executed in parallel to other steps of method 101.

Step 190 may include calculating various parameters such as an average response period, a number of requests that were assigned with a delay period without a delaying failure, the number of delaying failures, and the like.

Method 101 may include step 194 of searching, by the masking unit, for a type of a request that is associated with a response period that exceed a response period threshold. For example—requests that will result with very long (for example several minutes) response periods may be used by a hacker during a denial of service attack. The masking unit may search for such requests and send an alert to a system administrator, generate the alert, store the alert, and the like.

Method 101 may include step 196 of learning, by the masking unit, and during at least one learning period, the distribution of response periods of the computerized unit. One distribution can be learnt per one type of request and/or for a combination of a request and a response to the request.

Step 196 may be executed during any step of method 101, before the execution of any step of method 101 or after the execution of any step of method 101.

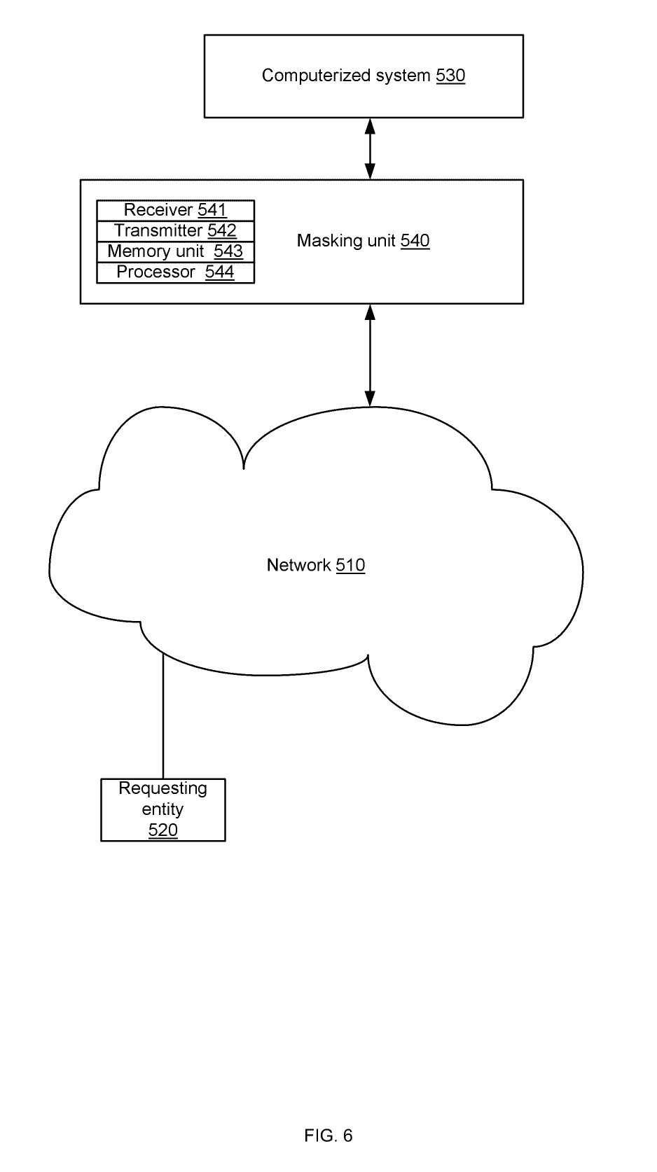

FIG. 6 illustrates a masking unit 540 and its environment according to an embodiment of the invention.

Network 510 such as the Internet, a local area network, a wide area network, or any type of network is connected to a requesting entity 520 and to the masking unit 540. The masking unit 540 is also coupled between the network 510 and the computerized system 530. The traffic between the network 510 and the computerized system 530 passes through masking unit 540.

FIG. 6 also illustrates masking unit 540 as including a transmitter 542 for transmitting the response to the requesting entity, a receiver 541 for receiving the request and the response, a memory unit 543 for storing requests and responses and a processor 544 for determining the delay period. A delay period may be introduced by delaying the retrieval of a response from the memory unit and feeding the request to the transmitter.

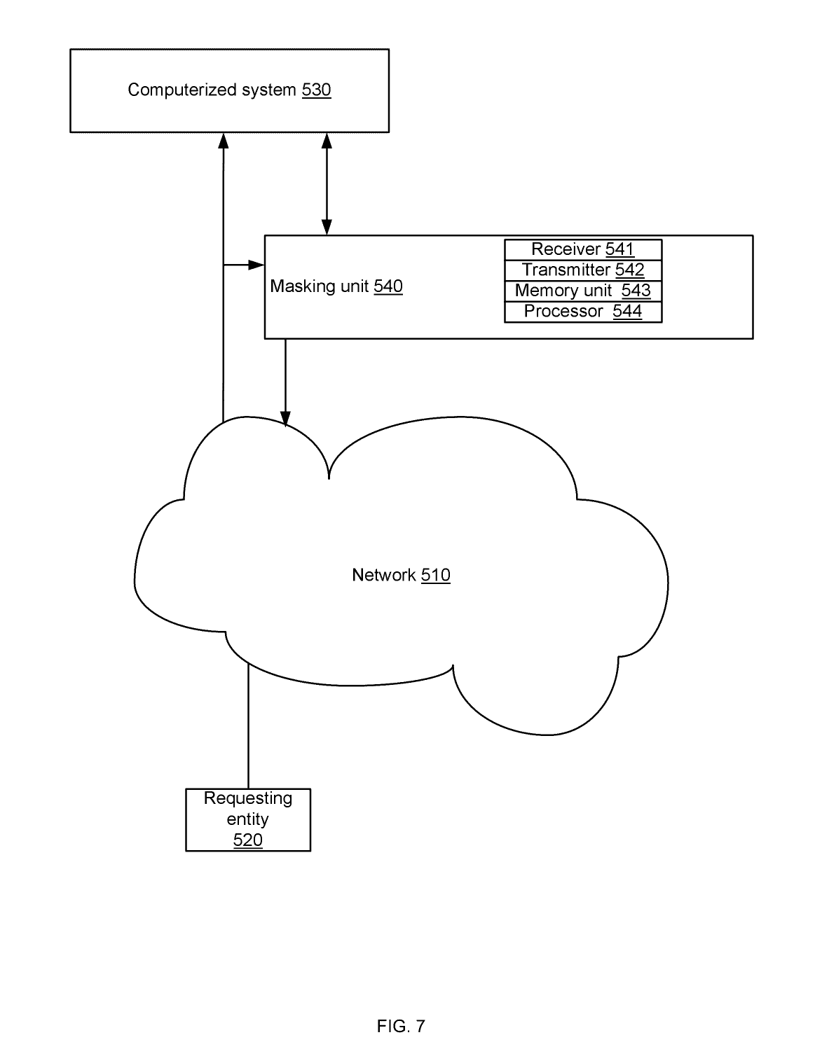

FIG. 7 illustrates a masking unit 540 and its environment according to an embodiment of the invention.

Network 510 such as the Internet, a local area network, a wide area network, or any type of network is connected to a requesting entity 520 and to the masking unit 540.

Traffic from the network 510 reaches the masking unit 540 and the computerized system 530. The traffic from the computerized system 530 towards the network 510 passes through masking unit 540. It is noted that the masking unit 540 may receive only part of the traffic—for example the masking unit 540 may receive only the responses to the requests. For example there may be a switch/router or any other computerized devices that may direct towards the masking unit 540 all or only some of the traffic.

FIGS. 6 and 7 illustrate a masking unit 540 that is separate from the computerized system 530 and may not require any change in the computerized system 530. This eases the implementation of the masking unit—especially in legacy computerized systems and/or computerized systems that are already installed.

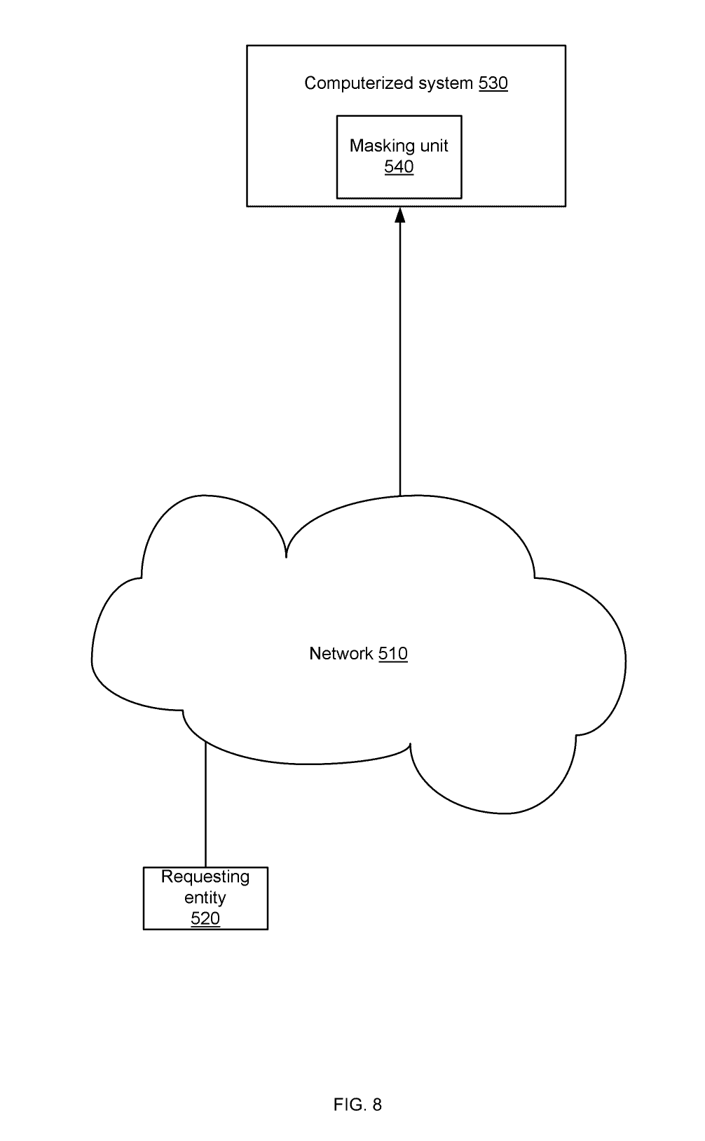

FIG. 8 illustrates a masking unit 540 and its environment according to an embodiment of the invention.

In FIG. 8 masking unit 540 is embedded in the computerized system 530.

The masking unit 540 may be a computerized system, a computer, a server, a mobile device, a proxy and the like. Alternatively, the masking unit 540 may be a non-transitory computer readable medium that stores masking instructions that may cause a hosting computerized system to execute any of the methods mentioned in the specification.

For example, masking instructions may be executed by a proxy that also hosts a web applicaiton firewall. The masking instructions may be a part of a firewall software and/or may be installed separately.

According to an embodiment of the invention the masking instructions may be installed in a proxy (or other computerized system) that also executes load balancing operations and/or any other type of operations.

The masking instructions and/or the masking unit may provide a tradeoff between delay periods—shorter delay periods reduce the latency of the masking process but longer delay periods provide a better masking. The tradeoff may change over time, and/or from one first class of requests to another, and/or from one type of response to another.

The following table provides an example to two types of responses and the success rate required from corresponding probability distributions that should be applied:

| | | | | | | |
|---|---|---|---|---|---|---|
| | | | | | Probability | |
| | | | | | distribution | Delaying |
| | | | | | success rate | failure |
| Protocol | From | To | Request | Response | and type | response |

Set 1. Name = approved payment requests.

| | | | | | | |
|---|---|---|---|---|---|---|
| HTTP/HTTPS | * | IP/port of | Payment | approved | Learning. | Return |
| | | the | request | | Confidence | immediately |
| | | computerized | | | level = | |
| | | system | | | 0.01% | |

Set 2. Name = rejected payment requests.

| | | | | | | |
|---|---|---|---|---|---|---|
| HTTP/HTTPS | * | IP/port of | Payment | disapproved | Learning. | Add delay |
| | | the | request | | Confidence | (+parameters) |
| | | computerized | | | level = | |
| | | system | | | 0.01% | |

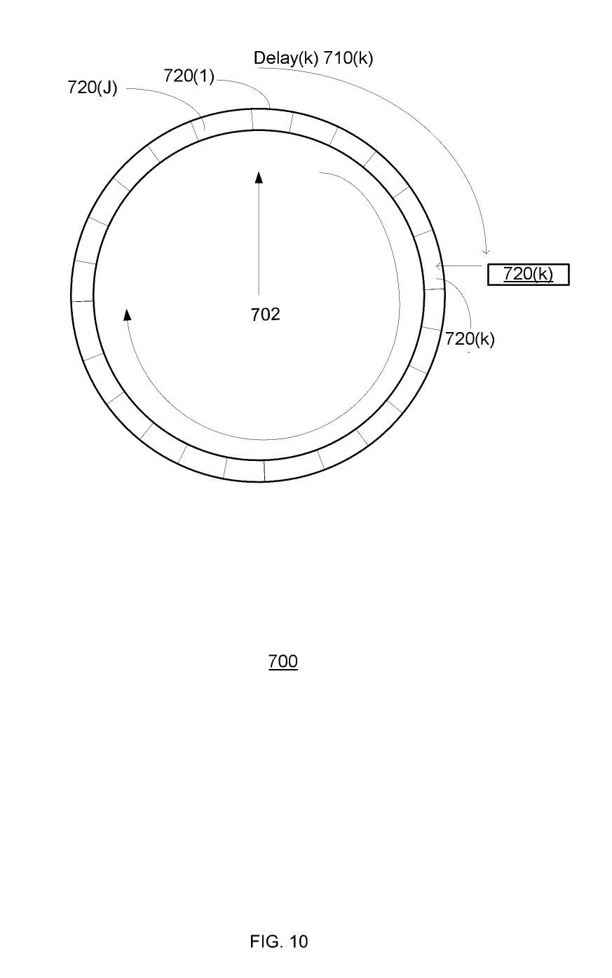

FIG. 10 illustrates a transmission control scheme according to an embodiment of the invention.

The time domain is segmented to multiple (J) time period that are associated with multiple virtual queues 720(1)-720(J)—one virtual queue per time period. Each virtual queue includes a token for each request that should transmitted during the corresponding time period. Arrow 702 points to the current point of time. The virtual queues are rotated clockwise thereby allowing the arrow 702 to scan the multiple virtual queues 720(1)-720(J) in a cyclic manner. FIG. 10 also illustrates that at time 702 the masking unit decided to delay a transmission of a response by k time periods (delay(k) 710(k)) and thus token 720(k) that represents the response is sent to the k'th virtual queue 720(k).

Any other method for transmission control may be applied.

The following text include three non-limiting examples in which some of the methods above are implemented:

The administrator of a credit cards company configures the masking unit to measure the distributions of payment requests that are accepted and payment requests that are rejected, and to adjust for each of them a function that will generate the new delay for them, with a desired security level. The administrator runs the masking unit without adding any delay, only for calculating the actual distribution of the responding time. Then the masking unit generates and applies two distribution functions that will mask the delay for each type of request.

The administrator of a server configured the masking unit to hide the responding time of a particular request. Due to an implementation bug in the server, an attacker succeeded to craft a malicious request that required additional processing time as a function of private data. Once the attacker sends the malicious requests to analyze the data several times, and the responding time exceeds the delay calculated by the masking unit, an alert is prompted to the administrator with the details of the requests. Now the administrator can either fix the bug and/or to further increase the security level and the delay time applied by the masking unit to overcome the attack.

An administrator of a website wants to test whether the login process to the website is vulnerable to timing attacks. The administrator configures the masking unit to measure the times of responding rejected and accepted login requests separately. Examination of the responding time distributions indicates on a leakage of information.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

Any combination of any steps of any of the mentioned above methods may be provided.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for masking timing information, the method comprises:
receiving, by a masking unit, a request that is generated by a requesting entity and is aimed to a computerized system;
receiving, from the computerized system, by receiver of the masking unit, a response to the request;
calculating, by the masking unit, a duration of a delay period; wherein the calculating of the delay period is responsive to at least one of the request and the response; and
wherein when the response to the request is received before a target point in time then delaying, by the masking unit, a transmission of the response to the requesting entity, until the target point in time, thereby masking timing information about a response period of the computerized system; and
wherein the target point in time exceeds a time of receiving the request by the delay period.

2. The method according to claim 1 wherein the calculating of the duration of the delay period follows the receiving of the response.

3. The method according to claim 1 wherein the calculating of the duration of the delay period precedes the receiving of the response and wherein the calculating of the delay period is responsive to the request and not to the response.

4. The method according to claim 1 wherein the calculating of the duration of the delay period precedes the receiving of the response and wherein the method further comprises updating, after the receiving of the response, the delay period based on the response.

5. The method according to claim 1, wherein the calculating of the duration of the delay period comprises applying a probability distribution function.

6. The method according to claim 5, comprising calculating or selecting the probability distribution function in response to the request.

7. The method according to claim 5, comprising receiving, by the masking unit, the probability distribution function.

8. The method according to claim 5, comprising calculating the probability distribution function in response to an expected success rate of the delaying; wherein a delaying failure occurs when the response to the request is not received before the target point in time.

9. The method according to claim 8, comprising monitoring an actual success rate of the delaying and changing the probability distribution function when the actual success rate deviates, by at least a deviation threshold, from the expected success rate.

10. The method according to claim 5, comprising:
detecting a delaying failure, wherein the delaying failure occurs when the response to the request is not received before the target point in time; and
responding to the delaying failure.

11. The method according to claim 10, wherein the responding to the delaying failure comprises sending a default response.

12. The method according to claim 10, wherein the responding to the delaying failure comprises calculating a new target point in time.

13. The method according to claim 10, wherein the responding to the delaying failure comprises transmitting the response to the requesting unit after the target point in time.

14. The method according to claim 13, comprising transmitting the response to the requesting unit upon a reception of the response by the masking unit.

15. The method according to claim 10, wherein the responding to the delaying failure comprises calculating a new target point in time by applying the probability distribution function.

16. The method according to claim 1, comprising detecting a potential delaying failure and responding to the potential delaying failure; wherein the potential delaying failure occurs when the masking unit failed to receive the response until a predefined period before the target point in time.

17. The method according to claim 16, wherein the responding to the potential delaying failure comprises transmitting to the requesting entity a default response.

18. The method according to claim 16, wherein the responding to the potential delaying failure comprises calculating a new target point in time.

19. The method according to claim 16, wherein the responding to the potential delaying failure comprises transmitting the response to the requesting unit after the target point in time.

20. The method according to claim 19, comprising transmitting the response to the requesting unit upon a reception of the response by the masking unit.

21. The method according to claim 1, comprising learning, by the masking unit, and during at least one learning period, distribution of response periods of the computerized unit.

22. The method according to claim 21, wherein the calculating of the duration of the delay period comprises applying a probability distribution function; and wherein the method comprises calculating the probability distribution function in response to the distribution of response periods of the computerized unit.

23. The method according to claim 21 wherein during a given learning period of the at least one learning period no response is delayed.

24. The method according to claim 21 wherein during a given learning period of the at least one learning period one or more responses are delayed.

25. The method according to claim 1, comprising searching, by the masking unit, for a type of requests that is associated with response periods that exceed a response period threshold.

26. The method according to claim 1 comprising delaying the transmission of the response only if the request belongs to first class of requests.

27. The method according to claim 1, comprising gathering, by the masking unit, delay period and response period statistics.

28. A non-transitory computer readable medium that stores instructions that once executed by a masking unit cause the masking unit to:
receive a request that is generated by a requesting entity and is aimed to a computerized system;
receive by receiver of the masking unit, a response to the request;
calculate a duration of a delay period; wherein the calculating of the delay period is responsive to at least one of the request and the response; and
wherein when the response to the request is received before a target point in time then delaying, by the masking unit, a transmission of the response to the requesting entity, until the target point in time, thereby masking timing information about a response period of the computerized system; and
wherein the target point in time exceeds a time of receiving the request by the delay period.

29. A masking unit, comprising a receiver, a transmitter, a processor and a memory unit; wherein the receiver is configured to receive a request that is generated by a requesting entity and is aimed to a computerized system and to receive from the computerized system, a response to the request; wherein the processor is configured to calculate a duration of a delay period; wherein the calculating of the delay period is responsive to at least one of the request and the response; and wherein when the response to the request is received before a target point in time then delaying, by the masking unit, a transmission of the response to the requesting entity, until the target point in time, thereby masking timing information about a response period of the computerized system; and wherein the target point in time exceeds a time of receiving the request by the delay period.

30. A method for masking timing information, the method comprises:
receiving, by a masking unit, a request that is generated by a requesting entity and is aimed to a computerized system;
receiving, from the computerized system, by receiver of the masking unit, a response to the request;
calculating, by the masking unit, a duration of a delay period; wherein the calculating of the delay period is not responsive to the request and is not responsive to the response; and
wherein when the response to the request is received before a target point in time then delaying, by the masking unit, a transmission of the response to the requesting entity, until the target point in time, thereby masking timing information about a response period of the computerized system; and
wherein the target point in time exceeds a time of receiving the request by the delay period.
